(19) United States
(12) Patent Application Publication
(10) Pub. No.: US 2004/0259554 A1
(43) Pub. Date: Dec. 23, 2004

(54) System and method for ray tracing using reception surfaces

(76) Inventors: Theodore S. Rappaport, Austin, TX (US); Roger R. Skidmore, Austin, TX (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/830,445

(22) Filed: Apr. 23, 2004

Related U.S. Application Data
(60) Provisional application No. 60/464,660, filed on Apr. 23, 2003.

(51) Int. Cl. H01Q 1/24

(52) U.S. Cl. 455/446; 455/423

(57) ABSTRACT

This invention provides a system and method for efficient ray tracing propagation prediction and analysis. Given a site-specific model of a physical environment, the present invention places virtual obstructions known as reception surfaces within the environment. As radio waves are predicted to propagate through the environment and intersect with or encounter reception surfaces, the characteristics of the radio wave are captured and stored relative to the location of the interaction with the reception surface. The radio frequency channel environment at any point within the site-specific model can be derived through analysis of the radio wave characteristics captured at nearby reception surfaces.

### CROSS-REFERENCE TO RELATED APPLICATIONS

This application claims priority and stems from provisional patent application No. 60/464,660 filed on Apr. 23, 2003, entitled “A Comprehensive Method and System for the Design and Deployment of Wireless Data Networks.” The disclosed invention is also related to U.S. Pat. No., 6,317,599, U.S. Pat. No. 6,442,507, U.S. Pat. No. 6,493,679, U.S. Pat. No. 6,499,006, U.S. Pat. No. 6,625,454, and U.S. Pat. No. 6,721,769; and the complete contents of these patents are herein incorporated by reference.

### BACKGROUND OF THE INVENTION

1. Field of the Invention

The present invention generally relates to radio wave propagation and the radio frequency (RF) design and prediction of wireless communication networks, and more particularly, to a site-specific ray-tracing method for determining the RF channel characteristics at any given position in a physical environment given wireless communication equipment transmitting within the physical environment.

2. Background Description

As data communications use increases, radio frequency (RF) coverage within and around buildings and signal penetration into buildings from outside transmitting sources has quickly become an important design issue for network engineers who must design and deploy cellular telephone systems, paging systems, wireless or wired computer networks, or new wireless systems and technologies such as personal communication networks, wireless local area networks (WLANs), ultrawideband networks, RF ID networks, and WiFi/WiMax last-mile wireless networks. Similar needs are merging for wireless Internet Service Providers (WISPs) who need to provision and maintain wireless connections to their customers. Designers are frequently requested to determine if a radio transceiver location or base station cell site can provide reliable service throughout an entire city, an office, building, arena or campus. Emerging network products provide real-time measurement of network behavior and use measured data to self-adjust network performance. A common problem for wireless networks is inadequate coverage, or a “dead zone” in a specific location, such as a conference room. Such dead zones may actually be due to interference, rather than lack of desired signal. It is understood that an indoor Voice over IP (VOIP) wireless PBX (private branch exchange) system or wireless local area network (WLAN) can be rendered useless by interference from nearby, similar systems, or by lack of coverage or throughput in desired locations.

The costs of in-building and microcell devices which provide wireless coverage are diminishing, and the workload for RF engineers and technicians to install and manage these on-premises systems is increasing sharply. Rapid engineering design, deployment, and management methods for microcell and in-building wireless systems are vital for cost-efficient build-out and on-going operation. The evolving wireless infrastructure is moving toward packet-based transmissions, and outdoor cellular may soon complement in-building Wireless LAN technology. See “Wireless Communications: Past Events and a Future Perspective” by T. S. Rappaport, et al., IEEE Communications Magazine, June 2002 (invited); and “Research Challenges in Wireless Networks: A Technical Overview, by S. Shakkottai and T. S. Rappaport at Proceeding of the Fifth International Symposium on Wireless Personal Multimedia Communications, Honolulu, Hi, October 2002 (invited).

Analyzing and controlling radio signal coverage penetration, network quality of service, and interference is of critical importance for a number of reasons. As more and more wireless networks are deployed in greater capacity, there will be more interference and more management and control needed, which in turn will create a greater need to properly design, measure, and manage, on an on-going basis, the aggregate performance of these networks, using real time autonomous management systems as well as sporadic or periodic adjustments to the wireless infrastructure. Not only will there be a need for properly setting the channels and operating parameters of indoor networks in an optimal or sensible setting upon network turn-on, but real time control will also be needed to guarantee quality of service to different types of wireless users (different class of users), some who may pay a premium for guaranteed data delivery or a more robust form of wireless network access, and other users who may want a lower class of service and who do not wish to pay for premium bandwidth access or who only need intermittent access to the network. Even if different user classes are not differentiated by payment, certainly the packet-based transmissions and demands of different classes of users (real time versus not-real-time, streaming video versus email, etc.) will require accurate prediction/simulation techniques, bandwidth control, and autonomous provisioning of traffic flows and network control.

Provisioning the Radio Frequency (RF) resources of networks will become more important as users increase and networks proliferate, and scheduling techniques and autonomous control of networks using simpler and more automated and embedded means will be critical for the success and proliferation of ubiquitous wireless networks.

When contemplating a wireless network, such as a Wireless LAN, broadband last-mile WiMax network, a mesh network, or a cellular network to offer service to a group of mobile or portable or fixed users, a design engineer must determine if an existing outdoor large-scale wireless system, or macrocell, will provide sufficient coverage and/or capacity throughout a building, or group of buildings (i.e., a campus), or if new hardware is required within the campus or buildings. Alternatively, network engineers must determine whether local area coverage will be adequately supplemented by other existing macrocells, or whether and where, particularly, indoor wireless transceivers (such as wireless access points, smart cards, sensors, or picocells) must be added. The placement and configuration of these wireless devices is critical from both a cost and performance standpoint, and the on-going maintenance and management of the network and the management of the performance of users on the network is vital to ensure network quality, quality of service (QoS) requirements, as well as reliability and security of the wireless network as more users come on the network or install nearby networks.

Not only must judicious planning be done to prevent new wireless indoor networks from interfering with signals from an outdoor macrocell or other nearby indoor networks at the onset of network deployment, but the designer must currently predict how much interference can be expected and where it will manifest itself within the building, or group of buildings ahead of time the best he or she can. Also, providing a wireless system that minimizes equipment infrastructure cost as well as installation cost is of significant economic importance.

The placement and configuration of wireless and wired equipment, such as routers, hubs, switches, cell sites, cables, antennas, distribution networks, receivers, transceivers, transmitters, repeaters, access points, or RF ID tag readers is critical from both a cost and performance standpoint. The design engineer must predict how much interference can be expected from other wireless systems and where it will manifest itself within the environment. In many cases, the wireless network interferes with itself, forcing the designer to carefully analyze many different equipment configurations in order to achieve proper performance. Sometimes power cabling is only available at limited places in a building or campus, thus decisions must be made with respect to the proper location and quantity of access points, and their proper channel assignments. Prediction methods which are known and which are available in the literature provide well-accepted methods for computing coverage or interference values for many cases.

Depending upon the design goals or operating preferences, the performance of a wireless communication system may involve tradeoffs or a combination of one or more factors. For example, the total area covered with adequate received or radio signal strength (RSSI), the area covered with adequate data throughput levels, and the numbers of customers that can be serviced by the system at desired qualities of service or average or instantaneous bandwidth allocations or delays are among the deciding factors used by network professionals in planning the placement of communication equipment comprising the wireless system, even though these parameters change with time and space, as well as with the number and types of users and their traffic demands.

It should be clear that a highly accurate method for properly determining the appropriate placement of equipment and optimal operating characteristics of a multiple-transmitter network (such as a Wireless LAN with many access points across a campus) is required in the original installation and start-up of a network. Given a reliable method for predicting the radio wave propagation environment and RF channel characteristics for any given location within the physical-environment, the interaction between mobile or fixed wireless users and the communications network, the performance of any given proposed or existing communications network can be predicted. This capability enables design engineers and network architects to determine and analyze the performance of a proposed arrangement and configuration of network equipment before an investment is made to deploy the network.

Deterministic radio wave propagation techniques involving ray tracing methods are well known in the art, and offer unprecedented accuracy for predicting wireless communication system performance. Ray tracing models are capable of estimating the complete spatial-temporal impulse response for any given receiver location. Information of that type would otherwise only be available through complex and often exhausting measurement collection. Ray tracing enables the ability to predict RMS delay spread, power delay profiles, mobile fading, angle-of-arrival, time dispersion, and any other channel characteristic. Such channel characteristics will be vital information for wireless engineers tasked with designing future wideband wireless communication systems.

However, even with advances in computing capabilities, use of ray tracing models is not yet widespread among wireless engineers. It is instead generally relegated to research labs and other non-commercial venues. This is due, in part, to various problems that continue to make ray-tracing models impractical. First, ray tracing is computationally intensive even by the computing standards of today. Secondly, there is a decided lack of highly detailed, readily available site-specific information of sufficient resolution for ray tracing models to be applied optimally. Third, there are no efficient techniques for calibrating ray tracing algorithms given measurement information; therefore, if the results of the ray-tracing algorithm do not closely match the measured data, a wireless designer has little to assist in adjusting the parameters of the algorithm to compensate.

The basic premise of ray tracing is to discretize electromagnetic waves emanating from a transmitter into a finite set of rays. These rays project outwards in straight lines from the transmitter. The rays trace a path through the physical environment, and attempt to mimic the actual path followed by electromagnetic waves. As the rays traverse through the physical environment, each physical obstruction encountered directly affects the trajectory of each ray. For example, a ray that intersects a wall may reflect off, diffract around the wall, penetrate through the wall, and/or be scattered by the wall. By tracing the paths all the rays take through the environment, an approximation of how transmitter power is distributed throughout the environment can be formed. Ray tracing is an approximation to the exact field equations, Maxwell's equations, at every single point in space of an environment of interest, as is the Finite Difference Time Domain (FDTD) method. By definition, we include both standard ray tracing and FDTD methods as being ray tracing methods in this specification.

The technique of ray launching is very popular as a ray tracing method. The concept is relatively simple—project rays outwards from transmit points and trace their trajectory as they reflect, diffract, and penetrate through the various surfaces in the environment. Individual rays are launched from transmitters and propagate through the modeled environment entirely independent of the other rays. Rays that pass arbitrarily close to a selected position determine the field strength at the position. That is, field strength at specific locations is determined on the basis of the various rays that pass nearby. The computation time of ray launching algorithms is more closely tied to the number of rays launched from the transmitter than from the number of surfaces within the site-specific environment model. The relative simplicity of ray launching lends itself very well to potential performance improvements. Although this particular type of ray tracing algorithm is utilized in the present embodiment of this invention, one skilled in the art can easily see how alternative ray tracing and radio propagation predictive techniques can be used within the scope of this invention. In the context of this document, the term “ray” shall represent a discrete portion of a radio frequency wave front, and “ray tracing” shall represent any technique used to estimate radio wave propagation through the use of rays.

Research efforts by many leading programs have attempted to model and predict radio wave propagation, many using ray tracing. Work by AT&T Laboratories, Brooklyn Polytechnic, and Virginia Tech are described in papers and technical reports entitled: S. Kim, B. J. Guarino, Jr., T. M. Willis III, V. Erceg, S. J. Fortune, R. A. Valenzuela, L. W. Thomas, J. Ling, and J. D. Moore, “Radio Propagation Measurements and Predictions Using Three-dimensional Ray Tracing in Urban Environments at 908 MHZ and 1.9 GHz,” IEEE Transactions on Vehicular Technology, vol. 48, no. 3, May 1999 (hereinafter “Radio Propagation”); L. Piazzi, H. L. Bertoni, “Achievable Accuracy of Site-Specific Path-Loss Predictions in Residential Environments,” IEEE Transactions on Vehicular Technology, vol. 48, no. 3, May 1999 (hereinafter “Site-Specific”); G. Durgin, T. S. Rappaport, H. Xu, “Measurements and Models for Radio Path Loss and Penetration Loss In and Around Homes and Trees at 5.85 GHz,” IEEE Transactions on Communications, vol. 46, no. 11, Nov. 1998; T. S. Rappaport, M. P. Koushik, J. C. Liberti, C. Pendyala, and T. P. Subramanian, “Radio Propagation Prediction Techniques and Computer-Aided Channel Modeling for Embedded Wireless Microsystems,” ARPA Annual Report, MPRG Technical Report MPRG-TR-94-12, Virginia Tech, July 1994; T. S. Rappaport, M. P. Koushik, C. Carter, and M. Ahmed, “Radio Propagation Prediction Techniques and Computer-Aided Channel Modeling for Embedded Wireless Microsystems,” MPRG Technical Report MPRG-TR-95-08, Virginia Tech, July 1994; T. S. Rappaport, M. P. Koushik, M. Ahmed, C. Carter, B. Newhall, and N. Zhang, “Use of Topographic Maps with Building Information to Determine Antenna Placements and GPS Satellite Coverage for Radio Detection and Tracking in Urban Environments,” MPRG Technical Report MPRG-TR-95-14, Virginia Tech, September 1995; T. S. Rappaport, M. P. Koushik, M. Ahmed, C. Carter, B. Newhall, R. Skidmore, and N. Zhang, “Use of Topographic Maps with Building Information to Determine Antenna Placement for Radio Detection and Tracking in Urban Environments,” MPRG Technical Report MPRG-TR-95-19, Virginia Tech, November 1995; S. Sandhu, M. P. Koushik, and T. S. Rappaport, “Predicted Path Loss for Roslyn, Va, Second set of predictions for ORD Project on Site Specific Propagation Prediction,” MPRG Technical Report MPRG-TR-95-03, Virginia Tech, March 1995, T.S. Rappaport, et al., “Indoor Path Loss Measurements for Homes and Apartments at 2.4 and 5.85 GHz, by Wireless Valley Communications, Inc., Dec. 16, 1997; Russell Senate Office Building Study, Project Update, Roger R. Skidmore, et al., for Joseph R. Loring & Associates; “Assessment and Study of the Proposed Enhancements of the Wireless Communications Environment of the Russell Senate Office Building (RSOB) and Associated Utility Tunnels,” AoC Contract # Acbr96088, prepared for Office of the Architect of the Capitol, Feb. 20, 1997; “Getting In,” R. K. Morrow Jr. and T. S. Rappaport, Mar. 1, 2000, Wireless Review Magazine; and “Isolating Interference,” by T. S. Rappaport, May 1, 2000, Wireless Review Magazine, “Site Specific Indoor Planning” by R. K. Morrow, Jr., March 1999, Applied Microwave and Wireless Magazine, “Predicting RF coverage in large environments using ray-beam tracing and partitioning tree represented geometry,” by Rajkumar, et al, Wireless Networks, Volume 2, 1996, “Global Optimization of Transmitter Placement in Wireless Communication Systems”, Accepted for publication in the IEEE Transactions on Wireless Communications Letters, October 2003 by J. He, A. Verstak, L. T. Watson, T. S. Rappaport, C. R. Anderson, N. Ramakrishnan, C. A. Shaffer, W. H. Tranter, K. Bae, J. Jiang; and, “Towards Integrated PSEs for Wireless Communications: Experiences with the S\hat{0}4W and SitePlanner Projects”, Submitted to ACM Journal Spring 2004, by R. R. Skidmore, A. Verstak, N. Ramakrishnan, T. S. Rappaport, L. T. Watson, J. He, S. Varadarajan, C. A. Shaffer, J. Chen, K. Kyoon Bae, J. Jiang, W. H. Tranter. In addition, researchers Greg Durgin, Neal Patwari, Scott Seidel, and Kurt Schaubach, all of Virginia Tech's Mobile and Portable Radio Research Group, worked with Prof. Rappaport and MPRG to produce much pioneering work in the field of ray tracing, and used the concept of the reception sphere in order to capture bouncing rays in a ray-tracing engine.

The aforementioned bodies of work, papers and technical reports are illustrative of the state-of-the-art in site-specific radio wave propagation modeling. While most of the above papers describe a comparison of measured versus predicted RF signal coverage, or describe methods for computing, representing or displaying predicted performance data based on ray tracing, they do not contemplate a method of radio wave propagation analysis involving reception surfaces for ray tracing, as disclosed herein. Instead, these sources utilize alternative, less efficient predictive techniques. Until the current invention, a method for site-specifically analyzing the performance of a wireless communications network involving the use of reception surfaces to capture predicted radio wave propagation data did not exist.

There are many computer aided design (CAD) products on the market that can be used to aid in some manner for wireless design or optimization, but none contemplate the use of reception surfaces as described herein. WiSE from Lucent Technology, Inc., SignalPro from EDX (now part of Comarco), PLAnet by Mobile Systems International, Inc., (later known as Metapath Software International, now part of Marconi, P.L.C.), decibelplanner from Marconi, and TEMS from Ericsson, Wizard by Safco Technologies, Inc. (now part of Agilent Technologies, Inc.), are examples of CAD products developed to aid in the design of wireless communication systems.

Agilent Technologies offers Wizard as a design tool for wireless communication systems. The Wizard system predicts the performance of macrocellular wireless communication systems based upon a computer model of a given environment using statistical, empirical, and deterministic predictive techniques.

Lucent Technologies, Inc., offers WiSE as a design tool for wireless communication systems. The WiSE system predicts the performance of wireless communication systems based on a computer model of a given environment using a deterministic radio coverage predictive technique known as ray tracing.

EDX offers SignalPro as a design tool for wireless communication systems. The SignalPro system predicts the performance of wireless communication systems based on a computer model of a given environment using a deterministic RF power predictive technique known as ray tracing.

WinProp offers a Windows-based propagation tool for indoor network planning made by AWE from Germany, and CINDOOR is a European university in-building design tool.

Marconi, P.L.C., offers both PLAnet and decibelPlanner as design tools for wireless communication systems. The PLAnet and decibelPlanner systems predict the performance of macrocellular and microcellular wireless communication systems based upon a computer model of a given environment using statistical, empirical, and deterministic predictive techniques. PLAnet also provides facilities for optimizing the channel settings of wireless transceivers within the environment, but does not provide for further adaptive transceiver configurations beyond channel settings.

Ericsson Radio Quality Information Systems offers TEMS as a design and verification tool for wireless communication indoor coverage. The TEMS system predicts the performance of indoor wireless communication systems based on a building map with input base transceiver locations and using empirical radio coverage models.

OPNET offers IT Guru and SP Guru as network design and management tools for wireless communication systems. Both provide facilities for managing a logical network layout and for estimating quality of service metrics. Neither IT Guru or SP Guru take into account a site-specific model of an environment, nor do they directly predict physical layer or RF channel characteristics. Further, they do not use reception surfaces in a ray tracing engine.

In addition, various systems and methods are known in the prior art with the regard to the identification of the location of mobile clients roaming on a wireless network, or for prediction of signals. Such systems and methods are generally referred to as position location techniques, and are well-known in the field for their ability to use the RF characteristics of the transmit signal to or from a mobile device as a determining factor for the position of the mobile device. Various papers such as P. Bahl, V. Padmanabhan, and A. Balachandran, “A Software System for Locating Mobile Users: Design, Evaluation, and Lessons,” April 2000, present various techniques for doing position location from signal strength measurements. Companies such as Wibhu, Ekahau, Polaris Wireless, and the radio camera concept from US Wireless (now defunct), use signal strength to estimate the position of wireless users. U.S. Pat. No. 6,259,924 to Alexander, Jr. et. al., U.S. Pat. No. 6,256,506 to Alexander, Jr., et. al., U.S. Pat. No. 6,466,938 to Goldberg, and Patent application No. 20020028681 to Lee, et. al., deal with estimating position locations using databases of measurements. None of these methods use reception surfaces with a ray tracing engine.

The above-mentioned design tools have aided wireless system designers by providing facilities for predicting the performance of wireless communication systems and displaying the results primarily in the form of flat, two-dimensional grids of color or flat, two-dimensional contour regions. None of the aforementioned design tools none contemplate the use of reception surfaces for ray tracing methods as part of their prediction method.

### SUMMARY OF THE INVENTION

The present invention presents a novel approach to the prediction and analysis of radio wave propagation and RF channel characteristics through the use of reception surfaces in ray tracing, in order to efficiently capture and retain predicted results. Reception surfaces are virtual objects of any shape or size that are represented within a computerized model of the physical environment, thus the popular reception sphere commonly used in ray tracing is found to be a very specialized, specific object much narrower in scope than the reception surface invention presented here. While reception surfaces are typically represented as horizontal and vertical planes in a 3-D environment, reception surfaces are not limited to any certain physical dimension or orientation. As radio waves are predicted to propagate through the environment, if the prediction analysis determines a radio wave has intersected with a reception surface, the incident ray information at that piercing point is stored in a computer for later retrieval and analysis, providing a mechanism for very efficiently tracking the progress of a radio wave throughout a site-specific environmental model in the computer.

The present invention provides significant benefit to the field of position location and RF channel prediction by enabling the a priori determination of the RF propagation and channel environment within the facility without the need for exhaustive measurement campaigns. The predictive capability of the invention enables the RF channel characteristics—a vital factor in position location algorithms, wireless network design and deployment techniques, and real time control of networks—to be determined very quickly and accurately. The predictive results generated from the reception surface model can then be processed and mapped onto a site-specific model of the environment for ready use in carrying out network predictions, position location displays, studies or analysis of location-specific data, or for use in network control applications. Using reception surfaces, it becomes possible to conduct site-specific ray tracing modeling to provide network performance predictions, including position location, network throughput performance throughout the environment, and predicting outage, BER, PER, FER, and other important metrics over areas of interest.

As in-building wireless LANs and microcell wireless systems proliferate, all of the issues facing network installers, carriers, network technicians, and end users may now be resolved quickly, easily, and inexpensively using the current invention. The current invention allows popular site-specific design, deployment, and real time network management products, such as those offered by Wireless Valley, to predict network performance using a more efficient ray-tracing approach based on the concept of reception surfaces.

As in-building wireless LANS, WiMax, and last-mile broadband wireless networks using MiMO and Mesh networking, as well as in-building UWB wireless networks proliferate, network performance and position location issues facing network installers, carriers, technicians, and end-users, and eventually autonomous network controllers, will be resolved quickly, easily, and inexpensively using the current invention. In addition to more efficient computation and computer representation in the ray tracing process, the current invention also displays predicted or measured network performance in an easily interpretable manner.

It is therefore an object of the present invention to facilitate the design, prediction, management, or control of wireless communication networks through the use of a novel method of reception surfaces for predicting the performance of network infrastructure. The resulting method can be used in pre-bid, design, and deployment applications, as well as in real-time or non-real time network control applications.

According to the present invention, a system is provided for allowing a communication network designer, network user, or autonomous controller to dynamically model a wired or wireless system electronically for representing any physical environment, by using site-specific models of the physical environment of interest. The method includes the selection and placement of models representing various wireless or optical or baseband communication network hardware components, such as antennas (point, omnidirectional, directional, adaptive, leaky feeder, distributed, etc.), base stations, base station controllers, amplifiers, cables, RF ID tags, RF ID readers, mobile or portable transmitter, receiver or transceiver devices, splitters, attenuators, repeaters, wireless access points, couplers, connectors, connection boxes, splicers, switches, routers, hubs, sensors, transducers, translators (such as devices which convert between RF and optical frequencies, or which convert between RF and baseband frequencies, or which convert between baseband and optical frequencies, and devices which translate energy from one part of the electromagnetic spectrum to another), power cables, twisted pair cables, optical fiber cables, and the like, as well as MIMO systems, and allows the user to visualize, in three-dimensions, the effects of their placement and movement on overall system/network performance throughout the modeled environment. For the purposes of this invention, the term “transceiver” shall be used to mean any network component that is capable of generating, receiving, manipulating, responding to, passing along, routing, directing, replicating, analyzing, and/or terminating a communication signal of some type. The placement of components can be refined and fine-tuned prior to actual implementation of a system or network, wherein performance prediction modeling or measurement may be used for design and deployment; and to ensure that all required regions of the desired service area are blanketed with adequate connectivity, RF coverage, data throughput, or possess other required network system performance values, such as acceptable levels of quality of service (QoS), packet error rate, packet throughput, packet latency, bit error rate, signal-to-noise ratio (SNR), carrier-to-noise ratio (CNR), signal strength or RSSI, rms delay spread, distortion, and other commonly used communication network performance metrics, known now or in the future, which may be measured or predicted and which may be useful for aiding an engineer in the proper installation, design, or ongoing maintenance of a wired or wireless communications network. In the case of an optical or baseband wired network, for example, the placement and performance of components can be visualized within the invention to ensure that proper portions of the environment are supplied with service, so that users within the environment may connect directly (with a hardwired connection) or via a wireless or infrared connection which can be provided throughout the wired network using translators, converters, wireless access points, and other communication components that facilitate frequency translation and wireless access from the wired network. The 2-D and 3-D visualization of system performance as predicted or measured using the method described herein provides network designers and maintenance personnel with tremendous insight into the functioning of the modeled wireless or wired communication system, and represents a marked improvement over previous visualization techniques.

To accomplish the above, a 2-D or 3-D site-specific model of the physical environment is stored as a CAD model in an electronic database. This model may be extensive and elaborate with great detail, or it may be extremely simple to allow low cost and extreme ease of use by non-technical persons wanting to view the physical layout of the network. The physical, electrical, and aesthetic parameters attributed to the various parts of the environment such as walls, ceilings, doors, windows, floors, foliage, buildings, hills, and other obstacles that affect radio waves or which impede or dictate the routing of wiring paths and other wired components may also stored in the database, such as performed using Wireless Valley SitePlanner or LANPlanner products. A representation of the environment is displayed on a computer screen for the designer to view. Note that the network/computer controller may display the screen remotely on a device different than where the computing and ray-tracing prediction is performed (e.g. through Internet web browsing or dedicated video channels), or may display the screen on a monitor which is part of the computer controller which implements the reception surface ray tracing prediction engine and other processing for network control signals. Furthermore, the computer controller may be distributed among different sites or computer platforms, either in the network or distributed between clients and servers, or co-located or located remotely from the actual network of interest. The designer may view the entire environment in simulated 3-D, zoom in on a particular area of interest, or dynamically alter the viewing location and perspective to create a “fly-through” effect.

Using a mouse or other input positioning device, the designer may select and view various communication hardware device models that represent actual communication system components from a series of pull-down menus. A variety of amplifiers, cables, connectors, and other hardware devices described above which make up any wired or wireless communication system or network may be selected, positioned, and interconnected in a similar fashion by the designer to form representations of complete wireless or wired communication systems. U.S. Pat. No. 6,493,679 entitled “Method and System for Managing a Real-Time Bill of Materials” awarded to Rappaport et al sets forth a preferred embodiment of the method for creating, manipulating, and managing the communication system infrastructure as modeled in the CAD software application.

In the present invention, the designer may use the invention to perform calculations to predict the performance of the communications network modeled within the environment. Performance is defined by any form of measurable criteria and includes, but is not limited to, adequate connectivity, RF coverage, data throughput, or required network system performance values, such as acceptable levels of quality of service (QoS), packet error rate, packet throughput, packet latency, bit error rate, signal-to-noise ratio (SNR), carrier-to-noise ratio (CNR), signal strength or RSSI, desired rms delay spread, distortion, and other commonly used communication network performance metrics, known now or in the future. The method presented additionally provides a means for visualizing the predicted performance values overlaid onto and/or embedded within the site-specific model of the environment. The present invention extends the prior art in this area by allowing a designer a quick, 3-D view of performance data overlaying the environment model. U.S. Pat. No. 6,317,599 entitled “Method and System for Automated Optimization of Antenna Positioning in 3-D” awarded to Rappaport et al. sets forth a preferred embodiment of the method for predicting the performance of a communications network within a site-specific model of the environment.

Through novel processing techniques provided by the present invention, the RF performance of any wireless network of equipment can be predicted. Radio waves transmitted from any source represented within the wireless network—or attached to any device interacting or interfering with the wireless network—are predicted to propagate through the site-specific model of the environment. Reception surfaces—virtual obstructions inserted into the site-specific environmental model that act as collection surfaces for radio wave data—are positioned, either automatically under computer control, or manually by the user, throughout the site-specific environmental model. As radio waves (rays) are predicted to move through the site-specific model and as they encounter these reception surfaces, all characteristics of the radio wave at the point in space at which the encounter with the reception surface occurs is recorded in memory. By later analyzing the reception surfaces, the RF channel environment at the point within the site-specific model of the environment bounded by or in close location to the reception surface can be accurately determined.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 depicts a flow diagram providing process steps employed in the invention;

FIG. 2 is a three dimensional perspective of a building floor plan;

FIG. 3 is a top-down view of a building floor plan containing transceivers and other communications network infrastructure;

FIG. 4 is a three-dimensional perspective of a building floor plan having been overlaid with horizontal and vertical reception surfaces;

FIG. 5 depicts a three-dimensional perspective of a building floor plan having been overlaid with horizontal and vertical reception surfaces; graphical icons representing radio waves having intersected with each reception surface are indicated;

FIG. 6 depicts a graphical representation of horizontal and vertical reception surfaces where the site-specific model has been hidden;

FIG. 7 depicts a selected point within a site-specific model that is bounded on all sides by six reception surfaces through which traced rays have passed;

FIG. 8 depicts the display of predicted radio wave propagation at a selected set of points within a site-specific environment model;

FIG. 9 depicts the real-time display of the predicted RF channel environment at a particular point within a site-specific environment model.

### DETAILED DESCRIPTION OF A PREFERRED EMBODIMENT OF THE INVENTION

The design of communication systems is often a very complex and arduous task, with a considerable amount of effort required to simply analyze the results of system performance. Using the present method, it is now possible to improve the accuracy and efficiency of the prediction of communication system performance. The present invention is a significant advance over the prior art through its use of a novel method of capturing and analyzing predicted radio wave propagation data in a ray tracing engine.

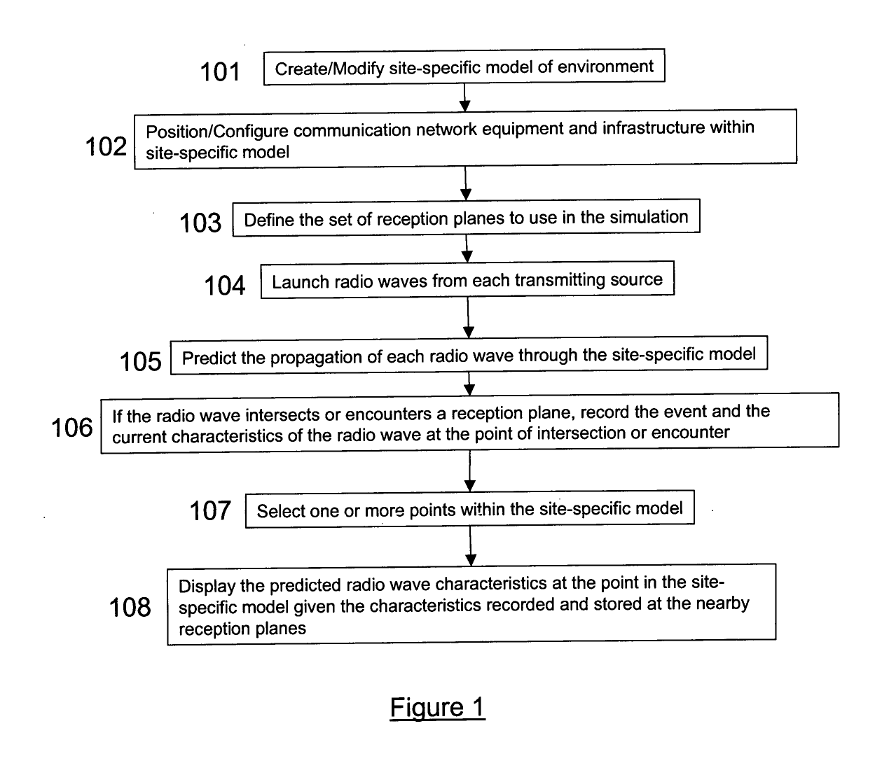

Referring now to FIG. 1, there is shown the general process of the present method. In order to begin analyzing a communication network, a site-specific computer representation of the environment in which the communication network is or will be deployed is created 101. The present invention uses 2-D or 3-D computer aided design (CAD) renditions of a part of a building, a building, or a collection of buildings and/or surrounding terrain and foliage. However, any information regarding the environment is sufficient, including 2-D or 3-D drawings, raster or vector images, scanned images, or digital pictures. The site-specific information is utilized by the present invention to enable visualization and relatively precise positioning of the communications infrastructure and to provide a model of the environment sufficient for performing visualizations that show the user measurements and/or predictions of network performance.

According to the invention, there is provided digital site-specific information regarding terrain elevation and land-use, building positions, tower positions, as well as geometries, height, and the internal layout of the walls, doors, ceilings, floors, furniture, and other objects within buildings, where the digital information may be in separate data formats or presentations, including two- or three-dimensional raster or vector imagery, and are combined into a single, three-dimensional digital model of the physical environment. Alternately, a series of 2-D images may be collected to represent the 3-D environment. The resulting three-dimensional digital model combines aspects of the physical environment contained within the separate pieces of information utilized, and is well suited for any form of display, analysis, or archival record of a wireless communication system, computer network system, or may also be used for civil utilities planning and maintenance purposes to identify the location of components, as well as their costs and specifications and attributes.

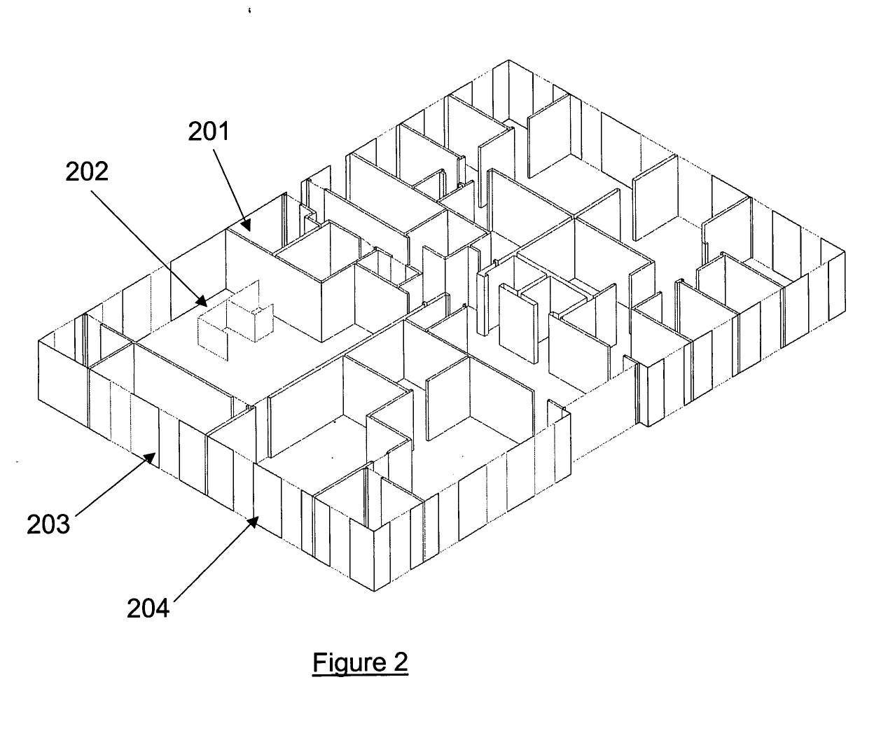

An example of a building environment as represented in the present invention is shown in FIG. 2. The various physical objects within the environment such as external walls 204, internal walls 201, cubicle walls 202, and windows 203 are represented within the model. Although a single floor of one building is shown for simplicity, any number of multi-floored buildings (or portions thereof) and the surrounding terrain may be represented within the invention. Any form of obstruction or clutter that could impact or alter the performance or physical layout of a communications network can be represented within the present invention. The electrical, mechanical, aesthetic characteristics of all obstructions and objects within the modeled environment may also be input and utilized by the invention. Such data is beneficial for improving the accuracy of performance predictions in wireless networks. For example, for wireless communication system design, the relevant information for each obstruction includes but is not limited to: material composition, size, position, surface roughness, attenuation, reflectivity, absorption, and scattering coefficient. For example, outside walls 204 may be given a 10 dB attenuation loss, signals passing through interior walls 201 may be assigned 3 dB attenuation loss, and windows 203 may show a 2 dB RF penetration loss.

This invention also enables a user to specify other physical, electrical, electromagnetic, mechanical, and aesthetic characteristics of any surface or object within the three-dimensional model. These characteristics include but are not limited to: attenuation, surface roughness, width, material, reflection coefficient, absorption, color, motion, scattering coefficients, weight, amortization data, thickness, partition type, owner and cost. In addition, information that is readily readable or writeable in many widely accepted formats, can also be stored within the database structure, such as general location data, street address, suite or apartment number, owner, lessee or lessor, tenant or ownership information, model numbers, service records, maintenance records, cost or depreciation records, accounting records such as purchasing, maintenance, or life cycle maintenance costs, as well as general comments or notes which may also be associated with any individual surface or building or object or piece of infrastructure equipment within the resulting three-dimensional model of the actual physical environment.

Note that all of these types of data specified in the preceding paragraphs typically reside in a computer CAD application which has the ability to iteratively or autonomously compute alternative communication network configurations of all network equipment, based on preset or user-specified design or operating points. However, these data records may also be digitized and passed between and/or stored at individual pieces of hardware equipment in the network for storage or processing at each particular piece of equipment.

Estimated partition electrical properties loss values can be extracted from extensive propagation measurements already published, which are deduced from field experience, or the partition losses of a particular object can be measured directly and optimized or preferred instantly using the present invention combined with those methods described in the U.S. Pat. No. 6,442,507 which is herein incorporated by reference.

Referring once more to FIG. 1, once the appropriate site-specific model of the environment has been specified 101, any desired number of hardware components, communications infrastructure, or equipment can be positioned, configured, and interconnected in the site-specific model 102. The communications network is site-specifically modeled within the invention by manual or automatic means, whereby the actual physical components used to create the actual physical network are modeled, placed and interconnected graphically, visually, and spatially within the site-specific database model in order to represent their proposed or actual true physical placements within the actual physical environment. This provides a site-specific model of a network of interconnected components within the database model.

Associated with at least some of the communication network components (sometimes referred to as infrastructure equipment or hardware) within the database model are infrastructure information, which may be in the form of data records, memory data, files, or text entries which contain the infrastructure information that is uniquely associated with every individual component in space within the modeled environment. That is, three different pieces of the same type of equipment within a network that is modeled within a city using this invention would have three distinct sets of infrastructure information records. The infrastructure information records are stored as either a linked list of textual or numeric information to the graphically represented components, or as data structures that are in some manner tagged or linked to the specific components within the database format.

The infrastructure information for each actual physical component may be represented in a site-specific manner within the environmental model of the physical environment, and such infrastructure information is preferably embedded within the environmental model 102 as described above. The embedding of infrastructure information for actual components may be done either prior to, during, or after the site-specific placement of the modeled components within the database model. The infrastructure information includes but is not limited to graphical objects representing the actual physical locations of infrastructure equipment used in the actual communication system, as well as data describing the physical equipment brand or type, a description of physical equipment location (such as street address, suite or apartment number, owner or tenant, latitude-longitude-elevation information, floor number, basement or subterranean designation, GPS or Snaptrack reading, etc.), equipment settings or configurations, desired or specified performance metrics or performance targets for the equipment whereby such desired or specified data are provided by the user or the prediction system, desired or specified performance metrics or performance targets for the network which the equipment is a part of, whereby such desired or specified data are provided by the user or the prediction system, measured performance metrics or network metrics as reported by the equipment, predicted alarm event statistics or outage rates, actual measured alarm event statistics or outage rates, alarm threshold settings or alarm metrics as reported by the equipment or the user or the prediction system, equipment orientation, equipment specifications and parameters, equipment manufacturer, equipment serial number, equipment cost, equipment installation cost, ongoing actual equipment upkeep costs and records, predicted ongoing equipment upkeep costs, equipment use logs, equipment maintenance history, equipment depreciation and tax records, predicted or measured performance metrics, equipment warranty or licensing information, equipment bar codes and associated data, information regarding methods for communicating with the physical equipment for the purposes of remote monitoring and/or alarming, alarm records, malfunction records, periodic or continuous performance or equipment status data, previous or current physical equipment users or owners, contact information for questions or problems with the equipment, information about the vendors, installers, owners, users, lessors, lessees, and maintainers of the equipment, and electronic equipment identifiers such as radio frequency identifiers (RF Ids or RF Tags), internet protocol (IP) addresses, bar codes, or other graphical, wired, or wireless address or digital signature.

The “equipment” or “component” above refers to any actual physical object or device, which may be mechanical or electrical or arterial in nature, or any architectural or structural element of a distributed network, including but not limited to wiring, piping, ducting, arteries, or other distributed components or infrastructure.

While the present invention discloses the reception surfaces and their use in a ray tracing engine, it should be clear that this capability can be used in many site-specific applications, including adaptive control capabilities of network management, position location estimation and prediction, and asset management of a wired or wireless communication network. Some preferred methods for embedding the infrastructure information within a site-specific environmental model and using this invention is detailed in U.S. Pat. No. 6,493,679, entitled “Method and System for Managing a Real Time Bill of Materials,” awarded to T. S. Rappaport et al, pending application Ser. No. 09/764,834, entitled “Method and System for Modeling and Managing Terrain, Buildings, and Infrastructure” filed by T. S. Rappaport and R. R. Skidmore which are hereby incorporated by reference, pending application ______ entitled “System and Method for Automated Placement or Configuration of Equipment for Obtaining Desired Network Performance Objectives and for Security, RF Tags, and Bandwidth Provisioning,” by Rappaport et al, which is hereby incorporated by reference. In addition, the prediction of performance of the RF effects of the physical equipment can be performed using the present invention within pending application Ser. No. 09/954,273, which is herein incorporated by reference, and which benefits from the current invention.

The resulting combined environmental and infrastructure model, wherein the modeled infrastructure and the associated infrastructure information for each component having been embedded in the environmental model in a site-specific manner, and also embedded in each piece of actual equipment, may then be stored onto any variety of computer-media. The combined model is understood to optionally include detailed cost data and maintenance data, as well as specific performance attributes and specific operating parameters of each piece of network hardware, some or all of which may be required for useable predictions and simulations and iterative control of the network. At any point in time, the combined environmental and infrastructure model may be retrieved from the computer media, displayed or processed in a site-specific manner with actual locations of components and component interconnections shown within the display of the modeled environment on a computer monitor, printer, or other computer output device, and/or edited using a computer mouse, keyboard or other computer input device known now or in the future. Furthermore, the combined model may also be embedded in software, or implemented in one or more integrated circuits, for real time or near real-time implementation in a hardware device, portable computer, wireless access point, or other remotely located device.

The editing above may involve changing any of the infrastructure or environmental information contained in the model, including any equipment or operating parameters of particular pieces of hardware that may be altered by the control of the computer CAD application of this invention. Such changes may happen whether the combined model is implemented in chip, embedded software, or standalone form.

Furthermore, the combined environmental and infrastructure models stored on computer media may contain models of infrastructure equipment that are capable of communicating and exchanging data with the CAD computing platform in real-time. For example, the invention may store desired network operating performance parameters that are communicated to certain pieces of actual equipment, and if the equipment ever measures the network performance and finds the performance parameters out of range, an alarm is triggered and reported to the invention for display, storage, processing, and possible remote retuning of pieces of equipment by the invention to readjust the network to move performance back into the desired range. The preferred method of this communication is described in pending application No. ______ entitled “System and Method for Automated Placement or Configuration of Equipment for Obtaining Desired Network Performance Objectives and for Security, RF Tags, and Bandwidth Provisioning,” by Rappaport et al, which is hereby incorporated by reference. Accessing and utilizing this communication link between the site-specific model of the communication network and the physical equipment can be performed by a variety of means, one of which is detailed in pending application Ser. No. 09/954,273, which is herein incorporated by reference.

The placement of infrastructure equipment may include cables, routers, antennas, switches, access points, and the like, or which would be required for a distributed network of components in a physical system. Important information that may be associated with some or all pieces of infrastructure equipment that are modeled by and maintained within the invention using the described database format includes physical location (placement of the equipment within the database so as to site-specifically represent its actual physical placement) as well as data such as equipment vendors, part numbers, installation and maintenance information and history, system or equipment performance and alarm data and history, as well as cost and depreciation information of the specific components and subsystems.

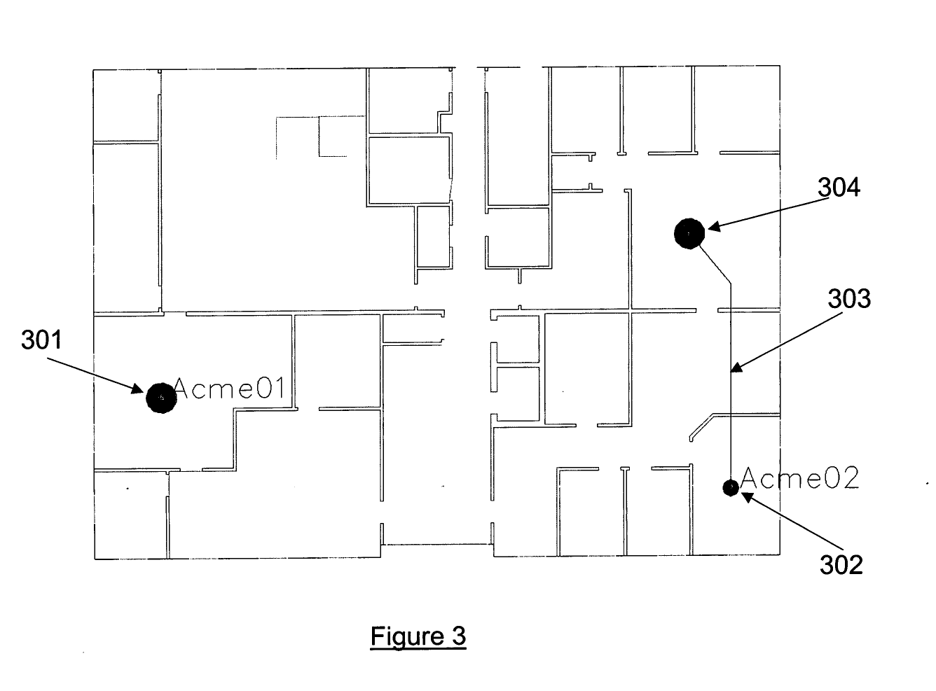

Referring to FIG. 3, there is shown the same site-specific environment as shown in FIG. 2. Using the preferred embodiment of the invention, an example communications network has been defined in FIG. 3. A transceiver 301 has been positioned within the site-specific environment. In addition, the second transceiver 302 has a coaxial cable 303 attached onto it. The coaxial cable 303 has been positioned within the facility and is itself connected to an antenna 304.

Referring to FIG. 1, once a communications network has been represented within the site-specific model of the environment, the invention allows for the automated or manual placement of reception surfaces within the site-specific environment model 103. Reception surfaces are virtual obstructions that, although not physically present within the environment, provide a means of tracking the progress of radio wave signals through the environment at locations where no actual obstruction exists (e.g., in mid-air). Reception surfaces may be thought of as invisible objects that have known positions to the ray-tracing engine, and when pierced by a ray, the computer implemented ray tracer keeps account (in memory or a predetermined array/vector) of that ray, and parameters such as its strength, its phase, its travel distance, its previously pierced reception surface, and which reception surface it just pierced. By providing this information along the path of a ray, it is possible to do a very fast memory computation to determine the strength, location, phase, polarization, time delay, etc. of each ray along its path. Thus, using the reception surface, it is possible to determine very quickly through table look up or memory read which rays are significant in amplitude or delay, which ones are not, etc.

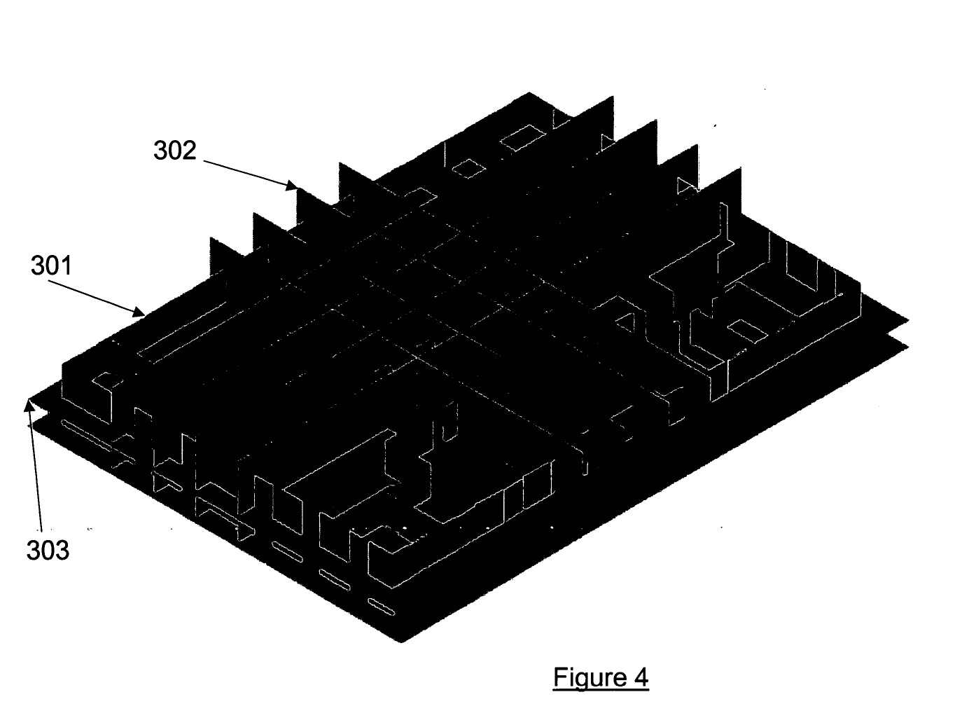

Referring to FIG. 4, there is shown the same site-specific environment 301 shown in FIG. 2. Vertical 302 and horizontal 303 reception surfaces have been inserted into the site-specific model 301. The reception surfaces in FIG. 3 take the form of horizontal 302 and vertical 303 planar surfaces that crisscross the site-specific model at various locations. Although depicted as orthogonal planar surfaces in FIG. 3, reception surfaces can take any geometric shape, size, angle, position, and orientation, and are not limited to being two-dimensional entities. For example, reception surfaces could be round, flat, curved, multi-sided or polygonal, spherical, cubical, conical, cylindrical, or take the form of a mesh or a surface of fluctuating elevation points. Although the present invention utilizes horizontal and vertical planar surfaces as reception surfaces, one skilled in the art can see how any other 2-D or 3-D geometrical shape could be used in the context of this invention.

The present invention provides the means for automatically positioning and spacing reception surfaces within the site-specific environment model. For example, rows of equally spaced horizontal and vertical reception surfaces may be automatically generated and integrated into the site-specific environment model. As a numerical example, if a resolution of 5 meters by 5 meters by 5 meters was deemed acceptable for reasonable ray tracing resolution prior to implementing the ray tracing engine, and the ray tracing engine was programmed to represent the borders of the modeled environment in order to determine if energy leaked out of or into the modeled environment, then a 100 m (Length) by 100 m (Width) ×20 m (Height) gymnasium building would be represented in the computer ray tracing engine to have vertical reception surfaces placed every 5 m apart on both the X and Y axes (thereby providing a 21×21 grid of reception planes that are vertically oriented, and which would be pierced by rays having some directional vector with a horizontal (XY plane) component. There would also be 6 horizontal reception surfaces, spaced 4 meters apart, horizontally oriented, that would be pierced by any ray that had a vertical (Z plane) component. Note that the specification of 5 m by 5 m by 5 m resolution in this example would not have to be specified a priori, but rather the ray tracing engine could already have a predetermined algorithm or approach to automatically select a desirable resolution, based on past learning or based on various accuracy tests or optimization algorithms it performs, possibly even without alerting the user.

While the above example illustrates reception surfaces as planes, alternatively, reception surfaces may be created and positioned manually within the site-specific environment model. A user of the present invention may select the geometric model, size, angle, orientation, interval, and position of reception planes within the site-specific environment model through use of a mouse or other computer pointing device capable of identifying positions within the site-specific environment model. In addition, there may be certain positions or regions within the site-specific environment model where a larger number or tighter spacing of reception surfaces than at other positions or regions is desirable, due to a more complicated physical environment or the need for more accuracy. The present invention accommodates this by either automatically calculating these regions or accepting input from a user to identify such regions and automatically increasing or decreasing the number and spacing of reception surfaces in or near the indicated region.

Referring to FIG. 1, once reception surfaces have been positioned within the site-specific environment model, a radio wave propagation predictive technique is used. This typically takes the form of radio waves being launched from transmit sources positioned within the site-specific model 104, and then tracking the progress of those radio waves as they interact with the physical environment 105. Although the present embodiment of this invention contemplates ray-tracing as the preferred method of predicting radio wave propagation, one skilled in the art can see that any other radio wave propagation prediction algorithm could be utilized.

Using ray tracing, individual rays representing discretized portions of radio waves are launched from transmitters. These radio waves propagate through the modeled environment entirely independent of the other rays. Rays lose energy and they propagate through the environment and interact with physical obstructions. When a ray comes into contact (or intersects) a physical obstruction modeled in the site-specific environment model, it will reflect off, diffract around, or transmit through the obstruction, or some or all of the above. The material characteristics of the obstruction define the final interaction between the ray and the obstruction. This process of using rays representing discretized of radio wave fronts and calculating the interaction of the rays with their environment is well-known in the literature.

The present invention improves upon the prior ray tracing methodologies with the introduction of the concept of reception surfaces. The addition of reception surfaces 103 as shown in FIG. 3, introduces virtual surfaces into the site-specific model. These virtual surfaces have no direct effect on the propagation of the traced rays; for the purposes of radio wave propagation analysis, the reception surfaces have negligible attenuation, reflectivity, surface roughness, and absorption qualities. Instead, the virtual reception surfaces serve as a means of tracking the progress of traced rays through the site-specific model of the facility. When a ray encounters or intersects with a reception surface, the location of the intersection or encounter is readily identifiable from the position of the reception surface and the current position and trajectory of the ray 106. The current characteristics of the radio wave, including trajectory, signal power, frequency, modulation, polarization, angle-of-arrival, propagation distance, physical obstructions intersected or encountered previously, elapsed time from the time the ray was transmitted, the antenna or source from which the ray was launched, unique identifier distinguishing the ray from all other rays, and any other characteristic, performance-related or otherwise, can then be stored relative to the position on the reception surface at which the intersection or encounter occurred.

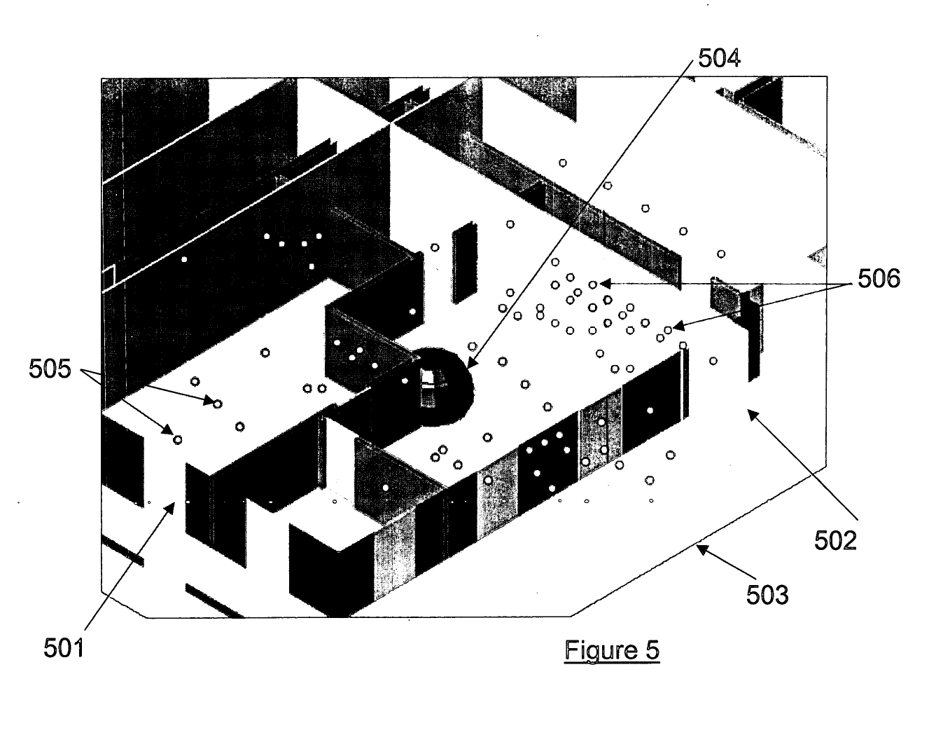

Referring to FIG. 5, there is depicted a portion of the site-specific model 501 from FIG. 2. Horizontal 502 and vertical 503 reception surfaces are spaced regularly through the site-specific model. A transceiver 504 is positioned within the site-specific model and is transmitting radio waves. Through use of a ray-tracing model, the radio wave fronts are discretized into rays; each ray is then traced through the site-specific model in order to approximate radio wave propagation. When a ray intersects with or encounters a reception surface 506, a record of the event is created and stored along with the relevant characteristics of the ray at that point within the site-specific environment model.

In the preferred embodiment of the invention, the storage mechanism used to store the ray characteristics relative to positions on reception surfaces is an external database associated with the site-specific environment model. The external database correlates positions on reception surfaces with the characteristics of the rays that intersect with or encounter the surfaces. This external database may be stored on the local computer or any external computing device. Thus, through use of reception surfaces, the status of radio waves propagating within the site-specific environment model may be captured and stored in an efficient manner.

It is also be possible to use CAD drawings without an external database, and to store ray data within the drawing, itself, at the locations corresponding to various reception surfaces.

As integrated circuits with special processing aimed at supporting site-specific prediction, measurement, or control methods become embedded in wireless devices worldwide, site-specific representations of physical environments may be represented electronically in the memories within ICs, or within operating systems, at which point the reception surface technique disclosed here could be implemented within a chip or distributed between devices, or embedded within an operating system.

Referring to FIG. 1, once the ray tracing prediction 106 has completed, one or more points within the site-specific model may be selected 107. This is accomplished using the mouse or computer pointing device, or may be automatically selected as being part of an indicated region or mesh. For example, the use may indicate a desire to view all points on a certain building floor or within a certain geographic region. Alternately, the user may indicate a desire to select all points meeting a certain criteria, such as all points at which a certain performance metric is achieved or not achieved. Alternatively, the region of interest may be specified automatically or selected by computer control.

At each selected point within the site-specific model, the present invention analyzes the surrounding or nearby reception surfaces to determine what, if any, radio wave intersections or encounters occurred that affect the given point 108. Given the characteristics of the radio waves as captured at the surrounding or nearby reception surfaces, the present invention can approximate the radio frequency channel environment at the selected location. For example, the present invention can determine and display relevant radio frequency channel metrics and network performance metrics such as connectivity, RF coverage, data throughput, level of quality of service (QoS), packet error rate, packet throughput, packet latency, bit error rate, signal-to-noise ratio (SNR), carrier-to-noise ratio (CNR), signal strength or RSSI, rms delay spread, distortion, and other commonly used communication network performance metrics, known now or in the future, which may be measured or predicted and which may be useful for aiding an engineer in the proper installation, design, or ongoing maintenance of a wired or wireless communications network. Because predicted ray intersections are captured and stored on each reception surface, variable resolution predictive results can be applied arbitrarily during the post-processing stage without the need to repeat the ray-tracing simulation; any arbitrary point within the site-specific model can be selected and an indication of the achievable network performance can be determined for that location.

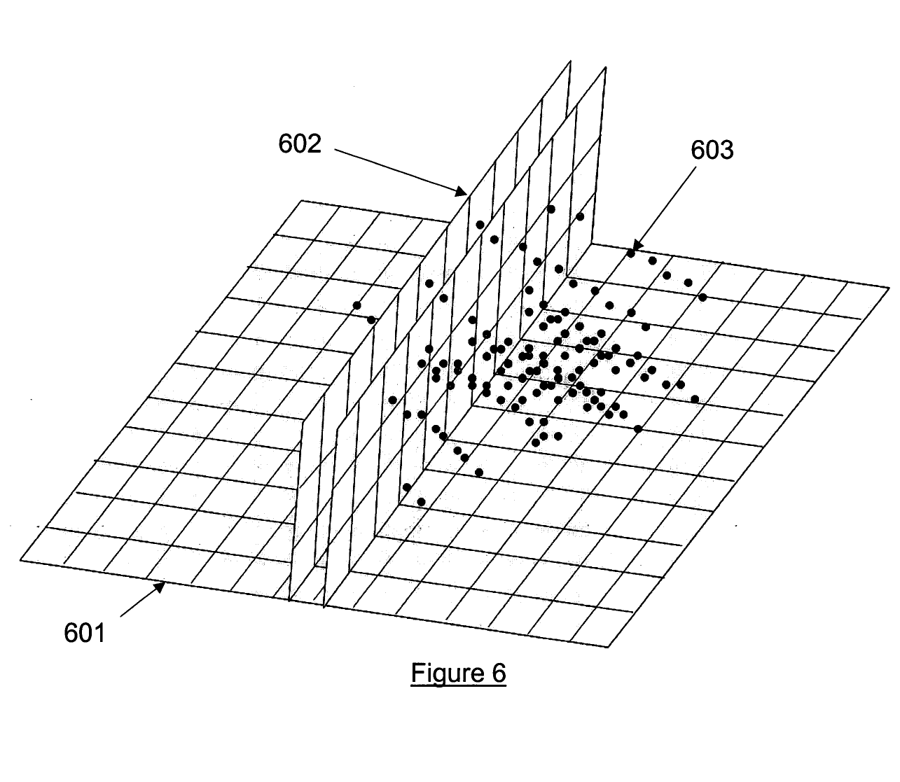

The preferred embodiment of the invention uses horizontal and vertical reception surfaces. The use of horizontal and vertical reception surfaces that crisscross the site-specific environment model results in any selected position within the site-specific model being enclosed within (bounded by) six reception surfaces. This allows for a more uniform post-processing analysis. Referring to FIG. 6, there is shown a representation of several horizontal 601 and vertical 602 reception surfaces with the site-specific model of the environment not displayed. Intersections or encounters with rays 603 are indicated in FIG. 6 by the dots on each reception surface. Each dot in FIG. 6 corresponds to an event record of an intersection or encounter between a ray and the given reception surface.

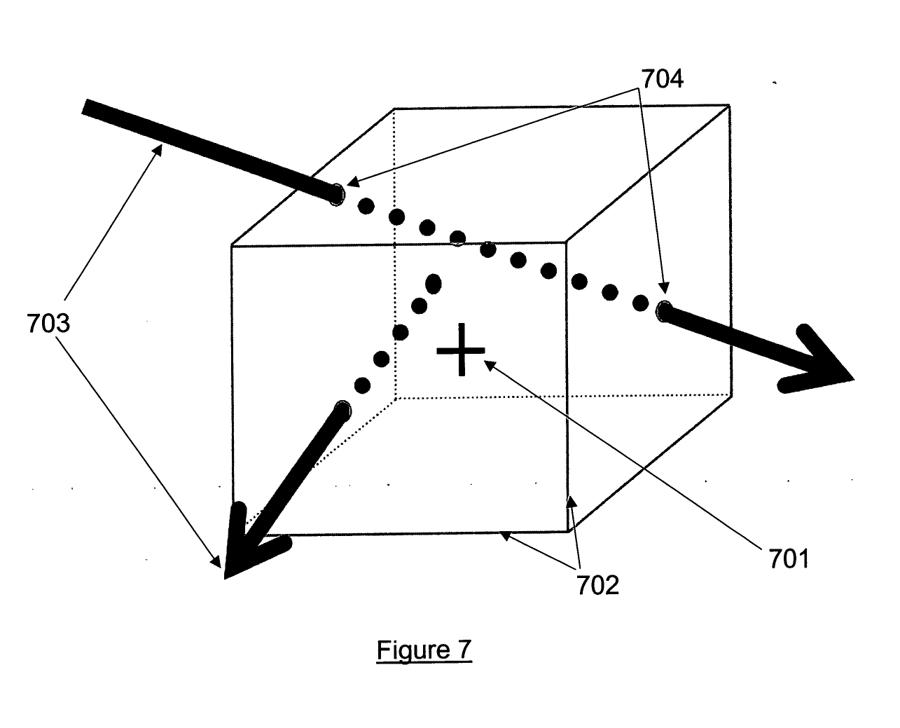

Note that the use of horizontal and vertical reception planes allows any arbitrary selected point within the site-specific model to be enclosed in a cube formed by the intersections of the reception surfaces. This is graphically illustrated in FIG. 7. Referring to FIG. 7, a point 701 has been selected within a site-specific model. Horizontal and vertical reception surfaces 702 were crisscrossed throughout the site-specific model such that the selected point is surrounded by six reception surfaces. Note that the reception surfaces selected to form the boundary surrounding the selected point need not be those reception surfaces closest to the selected point. A ray tracing simulation has been previously calculated for the site-specific model, and rays 703 have intersected the reception surfaces 702 at various locations 704. The ray intersections 704 on the enclosing reception surfaces 702 and the characteristics of the rays (for example, signal strength, propagation distance, angle of arrival, etc.) are used to determine the achievable network performance or some radio frequency channel parameter for the selected point 701.

The rays 703 that intersect the reception surfaces 702 forming the sides of the cube and the angles of their intersection are known through analysis of the reception surfaces bounding the selected point 701 and the corresponding records of intersections 704 or encounters with rays 703. This allows for an accurate determination of network performance metrics at any arbitrary point within the site-specific environment without the need to repeat the ray-tracing algorithm.

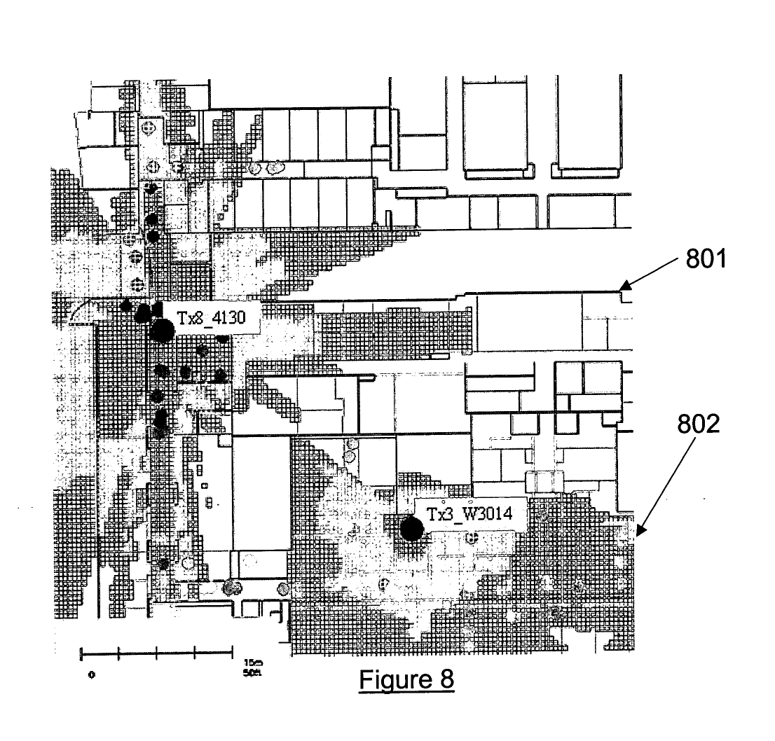

By associating network performance metrics or radio frequency channel characteristics with some form of graphical icon such as a color shaded pixel, cursor tooltip, textual string, geometric shape, or any other graphical entity or indicator, and then displaying the graphical icon within the context of the site-specific model, a visual presentation of the radio frequency channel environment or achievable network performance can be displayed at any selected point within the site-specific model. Referring to FIG. 8, there is shown a site-specific model of a building 801 wherein a ray-tracing prediction has been performed. A region of points within the site-specific model has been identified 802, and the network performance at each point has been calculated based on the ray intersection and encounter data stored at the reception surfaces bounding each point. The calculated network performance is then displayed graphically as a shaded pixel of color 802. The result is a shaded region of color overlaying the site-specific model, wherein the color and other characteristics of the pixels within the region correspond to a certain level of network performance or range of radio frequency channel metrics.

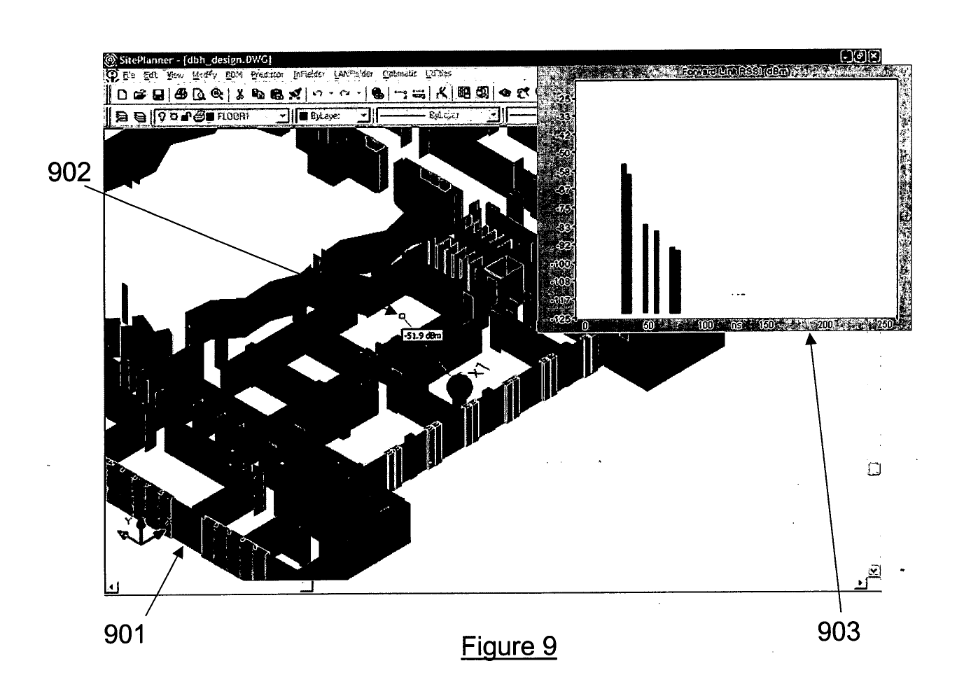

Referring to FIG. 9, there is shown an alternate type of display. A site-specific model 901 is shown wherein a ray-tracing prediction has been performed. As the user moves the mouse cursor 902 within the site-specific model, the point within the site-specific model at which the cursor resides is taken as the selected point for the purposes of analysis. The selected point is then analyzed in the context of the surrounding reception surfaces as described for FIG. 7, and network performance and radio frequency channel statistics for the selected point are determined. The result is displayed in the form of a graphical display 903 providing. visual cues to the user as to the calculated network performance metrics and radio frequency channel environment at the selected point. In FIG. 9, the graphical display 903 takes the form of a graph indicated a power delay profile. Other commonly displayed performance metrics include, but are not limited to power, E-field, signal loss, data throughput, level of quality of service (QoS), packet error rate, packet throughput, packet latency, bit error rate, signal-to-noise ratio (SNR), carrier-to-noise ratio (CNR), signal strength or RSSI, rms delay spread, distortion, and other commonly used communication network performance metrics.

By using the above mentioned computational methods it becomes possible to rapidly compute ray tracing predictions that are site-specific in nature. Futhermore, the above disclosure is not limited to wireless applications, but can be used to model any physical medium, including underwater, acoustical, or homogenous or non-homogenous environments where the velocity of a ray (wave) is known. In many cases, the velocity of the wave may be related to wavelength and frequency of the wave.

As disclosed in the prior art, wireless network site-specific predictions may be used to send control signals to equipment or devices in the network, thereby affecting a change (preferably an improvement) in overall network performance or at least for a particular user/device in the network, or a class of users on the network, or allowing more users to be accommodated, etc. In this way, real-time or sporadic, periodic, interrupt-driven, or alarm-based control is easily provided, as the computer controller is able to communicate to network devices/hardware using well-known protocols, as disclosed in some of the Wireless Valley patents cited above. Thus, using the reception suface approach in a ray tracing engine, it is possible to use predicted performance results, or rapid simulation results, to anticipate network performance. By anticipating network performance and adjustments that should be made, the predictions resulting from the ray-tracing predictions or simulations can be used to provide control signals for equipment in the network, to adjust the performance of the overall network or a user or class of users within the network. A fast prediction engine enables “what if” control scenarios to be computed at a network controller, and when the proper scenario is found, the network controller can use the prediction results to drive control signals to hardware in the network.

As wireless networks proliferate, the ability to measure, predict and control network performance will become more embedded within operating systems, and even within the silicon and integrated circuits of wireless devices, themselves. Thus, the disclosed method of performing ray tracing with reception surfaces, with their very rapid and easy computational technique, will be easily implemented in pipeline architecture and embedded silicon. In fact, it shall be possible to represent site specific models of a physical environment within memory or on hardware within radios, such information passed to the computer in each mobile device using the computer controller (e.g. the network controller) which transmits such physical modeling information over the air. It is also possible for the computer controller itself to reside within each radio device, or on the operating system of one or more computers used in a network. Thus, the computer controller (e.g. prediction engine or control device) may actually be within one or more pieces of infrastructure equipment or client device, The above methods for predicting network performance, using site specific information, will be able to be implemented on a chip or in memory in hardware or in an operating system, and this invention contemplates the ability to use reception surfaces within a chip, or embedded in an operating system, combined with the previously cited Wireless Valley patents and applications, which may also someday be implemented in an on-chip fashion or in an embedded operating system fashion.

While the invention has been described in terms of its preferred embodiments, those skilled in the art will recognize that the invention can be practiced with considerable modification within the spirit and scope of the appended claims.

Having thus described our invention, what we claim as new and desire to secure by Letters Patent is as follows:

1. A method for performing ray tracing, comprising the steps of:
Providing, in a computer, a computerized model which represents at least one physical environment where at least one communications network is installed or is contemplated to be installed;
Defining a desired spacing or desired resolution of reception surfaces for use in said computerized model, where said defining step may be performed manually by a user or performed automatically by said computer;
Running a ray tracing engine on said computer, whereby said ray tracing engine stores data pertaining to rays that interact with said reception surfaces;
Providing predictions of channel or network performance at one or more locations of interest in said computerized model, where said predictions are performed using data obtained from one or more interactions that one or more rays have with one or more reception surfaces, and where said one or more locations are selected by either (a) a human user or (b) by a computer.

2. A site-specific wireless network prediction, measurement, or control method, comprising the steps of:
Representing, in a computer, a computerized model of at least one physical environment where at least one communications network is installed;
Defining a desired spacing or desired resolution of reception surfaces for use in said computerized model, where said defining step may be performed manually by a user or performed automatically by said computer;
Running a ray tracing engine on said computer, whereby said ray tracing engine stores data pertaining to rays that interact with said reception surfaces;
Providing predictions of channel or network performance at one or more locations of interest in said computerized model, where said predictions are performed using data obtained from one or more interactions that one or more rays have with one or more reception surfaces, and where said one or more locations are selected by either (a) a human user or (b) by a computer; and
Using said predictions provided in said providing step to determine appropriate network control signals sent from a network controller to one or more devices in said at least one physical environment in order to alter the network performance of at least one device operating in said at least one in-building or campus network.
